(19) United States
(12) Patent Application Publication
(10) Pub. No.: US 2026/0105648 A1
(43) Pub. Date: Apr. 16, 2026

(54) ONE CLICK DYNAMIC STORYBOARDING USING TEXT GUIDANCE

(71) Applicant: ADOBE INC., SAN JOSE, CA (US)

(72) Inventors: Pranav Vineet Aggarwal, Santa Clara, CA (US); Midhun Harikumar, Sunnyvale, CA (US); Aashish Kumar Misraa, Santa Clara, CA (US)

(21) Appl. No.: 18/916,140

(22) Filed: Oct. 15, 2024

(51) Int. Cl. G06T 11/00; G06T 7/11

(52) U.S. Cl. CPC G06T 11/00; G06T 7/11; G06T 2207/20132

(57) ABSTRACT

A method, apparatus, non-transitory computer readable medium, and system for image processing include obtaining a text prompt describing a story, generating a first scene prompt and a second scene prompt based on the text prompt, where the first scene prompt describes a first scene of the story and the second scene prompt describes a second scene of the story, and generating a first synthetic image and a second synthetic image based on the first scene prompt and the second scene prompt, respectively, where the first synthetic image depicts the first scene and the second synthetic image depicts the second scene.

### BACKGROUND

The following relates generally to image processing, and more specifically to storyboard generation using a machine learning model. Image processing refers to the use of a computer to edit an image using an algorithm or a processing network. In some cases, image processing software can be used for various image processing tasks such as image restoration, image detection, image compositing, image editing, image generation, and storyboard generation. For example, storyboard generation includes the use of the machine learning model to generate a set of images sequentially arranged to outline events of a story described by the text prompt.

Storyboard is a visual representation of a narrative. For example, storyboard includes a set of images arranged in sequence to outline key scenes, actions, and events of a story. In some cases, each panel or frame of the storyboard represents a specific scene of the story, and each panel may include a caption title that summarizes actions depicted in the panel. In some cases, one or more elements of an image among the images of the storyboard can be modified by modifying the text prompt.

### SUMMARY

Aspects of the disclosure provide a method and system for storyboard generation. In one aspect, the system receives a text prompt describing a story and generates a storyboard based on the text prompt. In one aspect, the storyboard includes a plurality of synthetic images depicting elements of the story and a plurality of titles corresponding to the plurality of synthetic images, respectively. According to some aspects, the system includes a language generation model and an image generation model. In one aspect, the language generation model receives the text prompt and generates a set of scene prompts describing a set of scenes of the story, respectively. The image generation model is configured to receive the set of scene prompts and generates a set of synthetic images that depicts the scenes and elements described by the set of scene prompts, respectively. In some embodiments, the image generation model is configured to receive an image prompt to generate the set of synthetic images. In some cases, the identity of a character depicted in the synthetic images is the same as the character depicted in the image prompt. In some aspects, a storyboard component is configured to receive the set of synthetic images and a set of captions, respectively, corresponding to the set of synthetic images to generate the storyboard.

A method, apparatus, non-transitory computer readable medium, and system for image processing include obtaining a text prompt describing a story, generating, using a language generation model, a first scene prompt and a second scene prompt based on the text prompt, where the first scene prompt describes a first scene of the story and the second scene prompt describes a second scene of the story, and generating, using an image generation model, a first synthetic image and a second synthetic image based on the first scene prompt and the second scene prompt, respectively, where the first synthetic image depicts the first scene and the second synthetic image depicts the second scene.

A method, apparatus, non-transitory computer readable medium, and system for image processing include obtaining a text prompt and an image prompt; generating, using a language generation model, a first scene prompt and a second scene prompt based on a text prompt; and generating, using an image generation model, a first synthetic image and a second synthetic image based on the image prompt and based on the first scene prompt and the second scene prompt, respectively.

An apparatus and system for image processing include a memory component and a processing device coupled to the memory component, the processing device configured to perform operations comprising: obtaining a text prompt and an image prompt, where the text prompt describes a story and the image prompt depicts an element of the story, generating a first scene prompt and a second scene prompt based on the text prompt, where the first scene prompt describes a first scene of the story and the second scene prompt describes a second scene of the story, and generating a first synthetic image and a second synthetic image based on the image prompt, the first scene prompt, and the second scene prompt, where the first synthetic image depicts the first scene including the element and the second synthetic image depicts the second scene including the element.

### BRIEF DESCRIPTION OF THE DRAWINGS

FIG. 1 shows an example of an image processing system according to aspects of the present disclosure.

FIG. 2 shows an example of a method for conditional image generation according to aspects of the present disclosure.

FIG. 3 shows an example of storyboard generation according to aspects of the present disclosure.

FIG. 4 shows an example of a method for generating a storyboard using a text prompt according to aspects of the present disclosure.

FIG. 5 shows an example of an image processing apparatus according to aspects of the present disclosure.

FIG. 6 shows an example of a storyboard generation system according to aspects of the present disclosure.

FIG. 7 shows an example of an image generation model according to aspects of the present disclosure.

FIG. 8 shows an example of a U-Net architecture according to aspects of the present disclosure.

FIG. 9 shows an example of a diffusion process according to aspects of the present disclosure.

FIG. 10 shows an example of a method for modifying a scene prompt according to aspects of the present disclosure.

FIG. 11 shows an example of a flow diagram depicting an algorithm as a step-by-step procedure in an example implementation of operations performable for training a machine learning model according to aspects of the present disclosure.

FIG. 12 shows an example of a method for training a diffusion model according to aspects of the present disclosure.

FIG. 13 shows an example of a computing device according to aspects of the present disclosure.

### DETAILED DESCRIPTION

The following relates to image processing, and more specifically to storyboard generation using generative machine learning. Embodiments of the disclosure relate to a storyboard generation system that efficiently and accurately generates a storyboard from an input text prompt describing a story. In one aspect, the system includes a language generation model configured to generate a set of scene prompts describing scenes of the story. In one aspect, the system includes an image generation model configured to receive an image prompt depicting a character and the set of scene prompts to generate a set of synthetic images depicting the scenes and the character. By using the image prompt to guide the image generation model, the system ensures accurate image content generation consistent with the text description of the scene prompts.

According to some embodiments, the system includes a language generation model configured to generate a set of scene prompts respectively describing a set of scenes of the story based on the text prompt. In some embodiments, the system includes an image generation model configured to generate a set of synthetic images based on the set of scene prompts, respectively. In some embodiments, the set of synthetic images is generated based on an image prompt depicting a character. In some cases, for example, the image prompt is generated based on an identity text prompt using the image generation model. In some cases, the image embedding of the image prompt is combined with each of the text embedding of each of the scene prompts to guide the image generation process to generate the synthetic images.

In some aspects, the system includes a storyboard component configured to generate a storyboard including a set of panels. For example, a set of captions respectively corresponding to the set of synthetic images and the set of synthetic images are input into the storyboard component. In some cases, the storyboard includes a set of panels, where each panel includes a synthetic image and a corresponding caption. In some cases, the panels are arranged sequentially based on the story.

A subfield in image processing relates to storyboard generation. For example, storyboarding is an essential step towards generating motion graphics movies and other digital media for storytelling. Conventional storytelling is done by a human script writer who creates a story-script, and a human artist then converts the storyboard to story panels that represent the style of the image. In some cases, the process of storyboard generation involves multiple skilled artists in the field of script writing and image creation. In some cases, storyboarding involves multiple weeks of work and iterations.

Some conventional methods in generating storyboard involve the use of machine learning models. In some cases, conventional systems generate storyboard using deep learning architectures such as a transformer or convolutional neural network (CNN) may be computationally expensive and time-consuming. For example, these systems have trouble in generating high-resolution synthetic images with complex tasks such as generating detailed scene composition. In some cases, these systems cause delayed feedbacks to users and reduce system efficiency.

Some conventional systems are unable to accurately understand the complex scene descriptions from a text prompt and generate the corresponding synthetic image in text-to-image generation. For example, these systems may generate inaccurate or ambiguous images or pixels when provided with abstract text instructions. Accordingly, these systems may result in visually incoherent outputs. As a result, this leads to additional and unwanted manual editing from, for example, a user.

In some cases, the performance of these systems depend heavily on the quality and diversity of the training data. For example, if a model is trained on limited or biased dataset, then the output of the model may be less diverse and representative. For example, if the model is trained on a specific genre, then the model may struggle to generate storyboards for different styles. Accordingly, the generalization of these conventional systems may be impacted based on the training dataset.

Embodiments of the disclosure improve on conventional image generation models by generating a storyboard more efficiently and accurately based on an input text prompt that describes a story. This is achieved using a system that includes a language generation model and an image generation model (e.g., a zero-shot image generation model). In one aspect, the language generation model is configured to generate a set of scene prompts that describes one or more scenes, actions, and/or events of the story. The set of scene prompts are provided to the zero-shot image generation model to ensure the diverse image content generation while maintaining the plot (or the sequence of events) of the story. In one aspect, the image generation model takes an image prompt as input to ensure that the identity of the character described in the story is preserved and consistent throughout the frames of the storyboard.

In one aspect, the image generation model is a zero-shot image generation model. For example, the zero-shot image generation model generates a synthetic image based on one or more input prompts (e.g., text prompt or image prompt) without specific training on the input prompt. In one aspect, the model can generate images from text prompts that the model has not explicitly seen before. For example, if the model was never trained on the phrase “a red panda playing guitar”, the model can still generate an accurate image based on the understanding of the model of “red panda” and “guitar”. In some cases, the model is pretrained on diverse data in the shared latent space between text and image. Accordingly, the model can generalize across different combinations of objects, actions, and styles, allowing the model to generate new visual concepts based on the text description.

According to some aspects, the image embedding of the image prompt and each of the text embeddings of scene prompts are combined or concatenated. By doing so, the image generation model can accurately generate one or more synthetic images that preserve the identity of the character depicted in the image prompt while generating accurate image contents that align with the scenes described by the scene prompts. In some embodiments, a modified scene prompt may be obtained based on a modification command from a user. For example, the modified scene prompt may describe a change of an image element. By using the modified scene prompt, the image generation model can generate a modified synthetic image depicting the change of the image element.

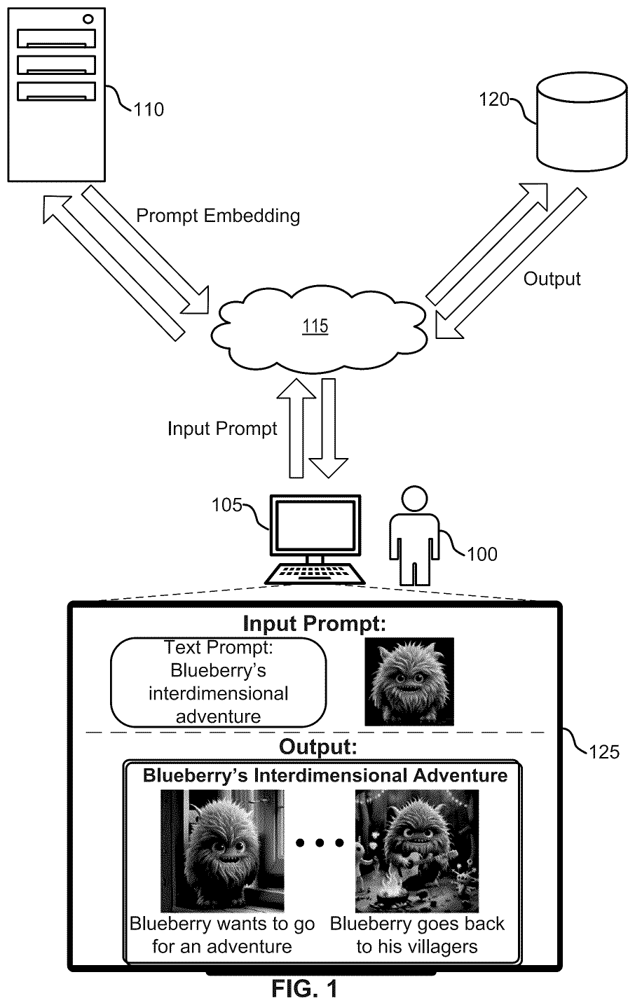

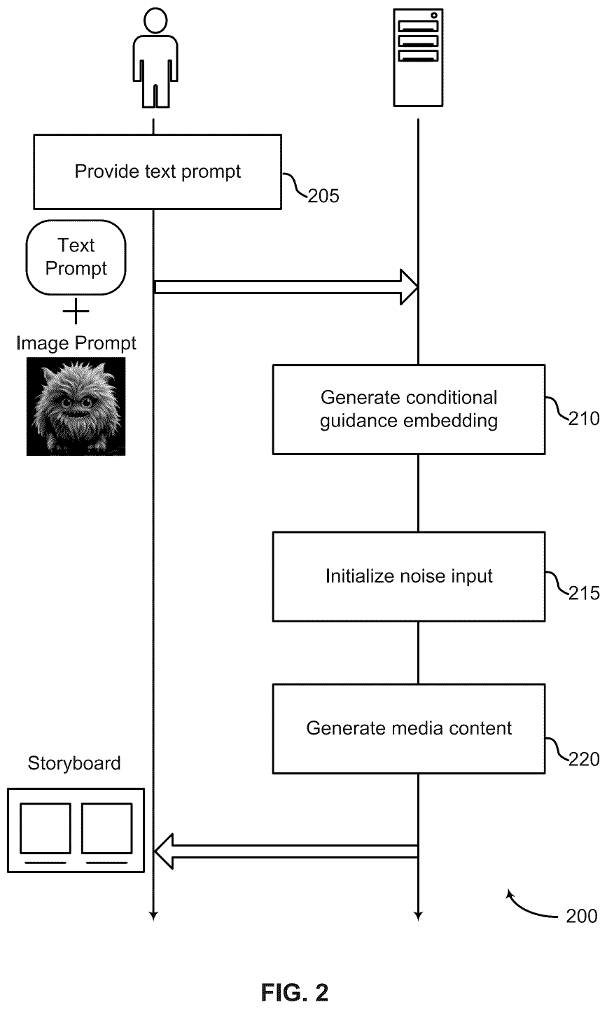

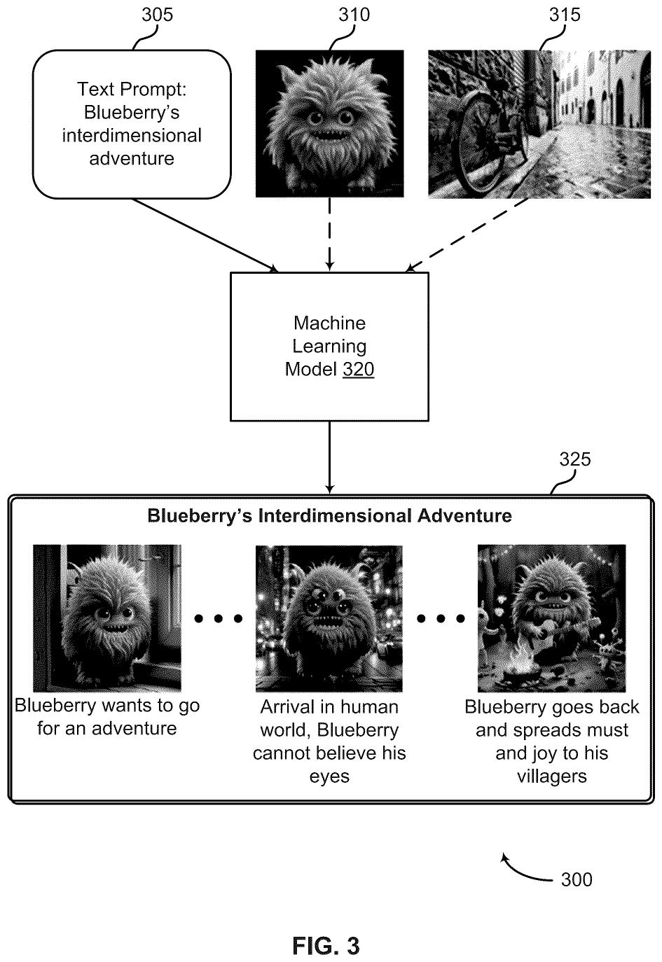

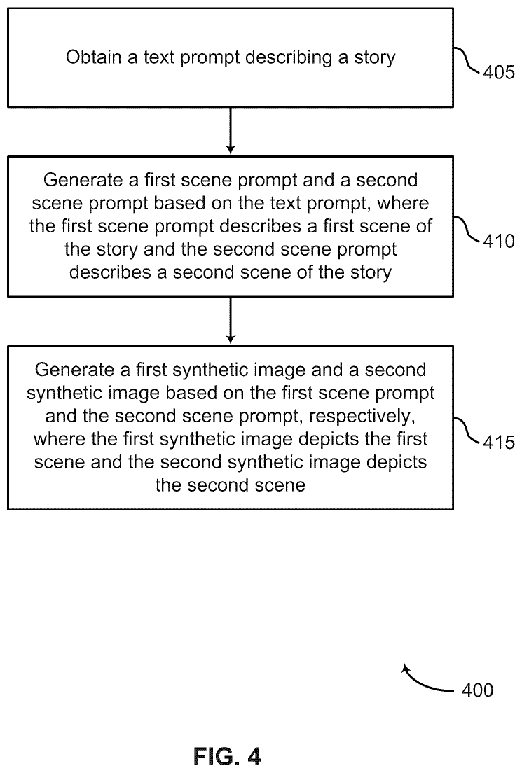

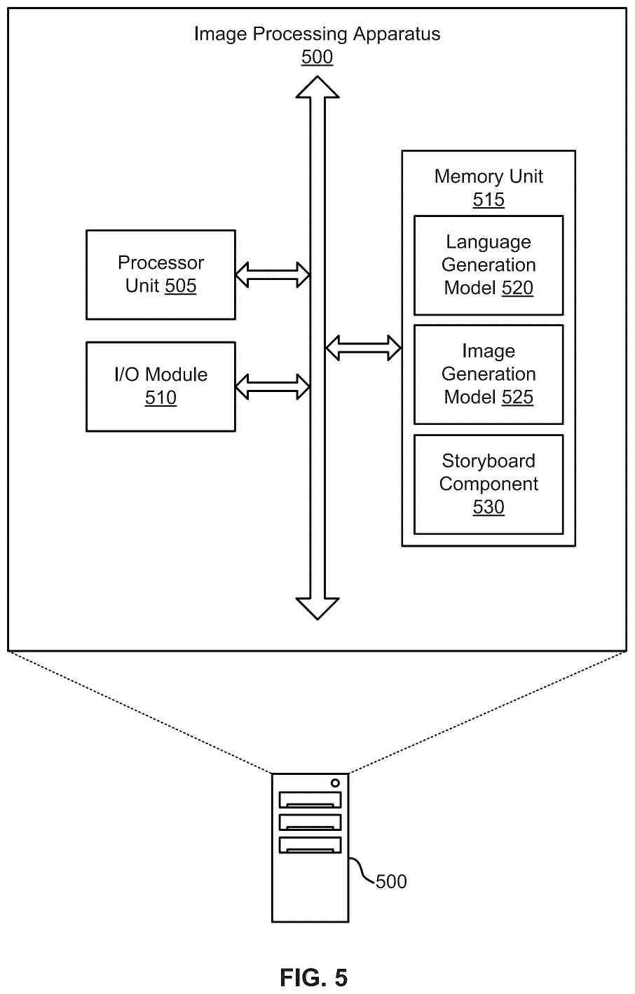

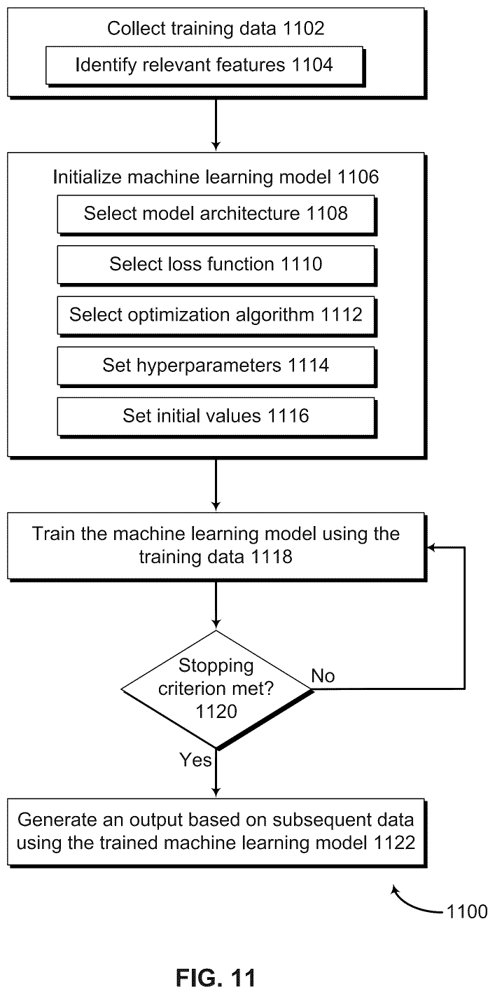

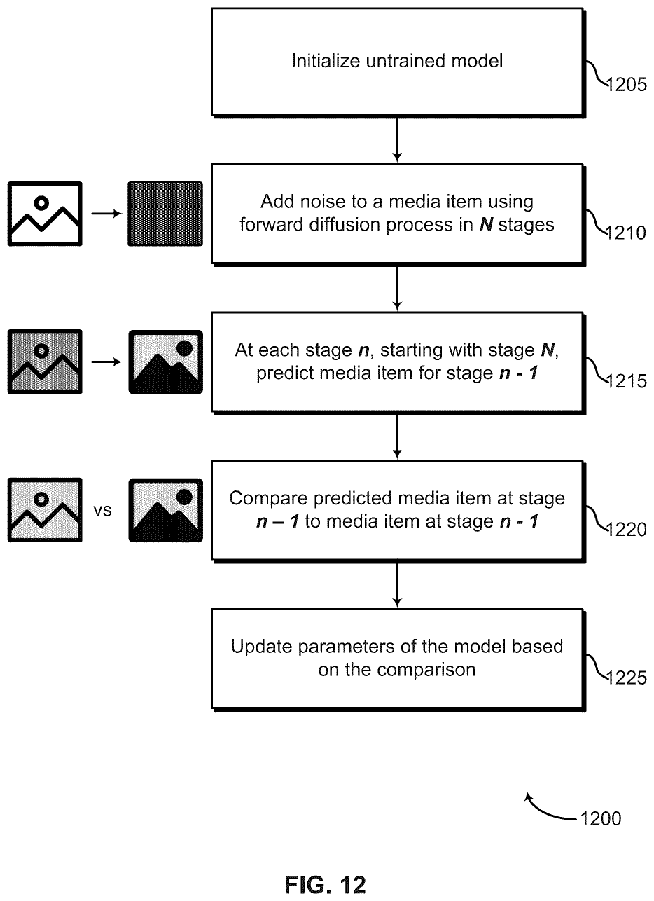

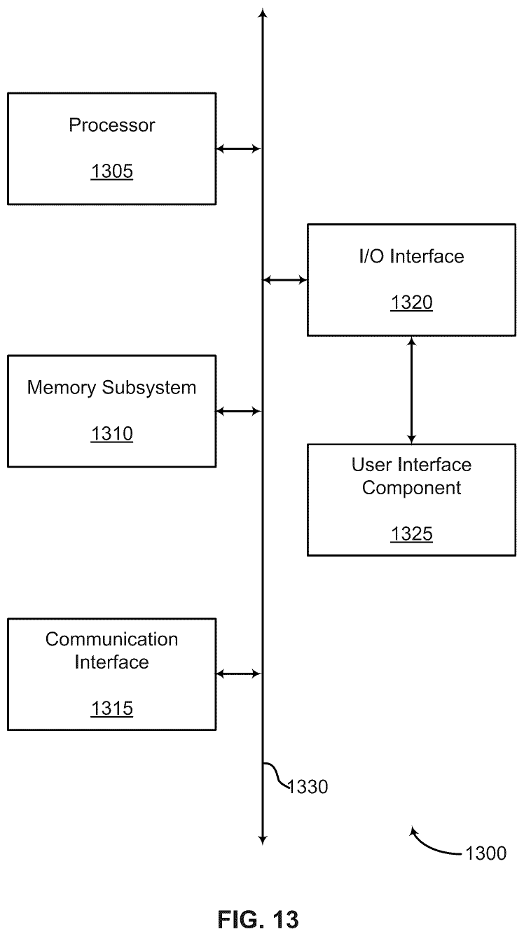

An example system of the inventive concept in image processing is provided with reference to FIGS. 1 and 13. An example application of the inventive concept in image processing is provided with reference to FIGS. 2-3. Details regarding the architecture of an image processing apparatus are provided with reference to FIGS. 5-8. An example of a process for image processing is provided with reference to FIGS. 4 and 9-10. A description of an example training process is provided with reference to FIGS. 11-12.

Accordingly, the present disclosure provides a system and method that improve on conventional systems by efficiently and accurately generating a storyboard including a set of story panels from a single input text prompt that describes a story. In some embodiments, the system receives an image prompt depicting a character to generate the synthetic images of the storyboard. By guiding the image generation model of the system using the image prompt, the character depicted in the image prompt can be incorporated into one or more synthetic images in the story panels. In some aspects, one or more image elements of the synthetic images of the story panels can be independently or jointly modified by editing one or more corresponding elements of the scene prompts generated using the language generation model.

### Storyboard Generation

In FIGS. 1-4 and 9-10, a method, apparatus, non-transitory computer readable medium, and system for image processing include obtaining a text prompt describing a story, generating, using a language generation model, a first scene prompt and a second scene prompt based on the text prompt, where the first scene prompt describes a first scene of the story and the second scene prompt describes a second scene of the story, and generating, using an image generation model, a first synthetic image and a second synthetic image based on the first scene prompt and the second scene prompt, respectively, where the first synthetic image depicts the first scene and the second synthetic image depicts the second scene.

Some examples of the method, apparatus, non-transitory computer readable medium, and system further include obtaining an image prompt depicting an element of the story, where the first synthetic image and the second synthetic image are generated based on the image prompt and depict the element. Some examples of the method, apparatus, non-transitory computer readable medium, and system further include obtaining an identity text prompt describing the element. Some examples further include generating the image prompt based on the identity text prompt. Some examples of the method, apparatus, non-transitory computer readable medium, and system further include obtaining a preliminary image of a person. Some examples further include cropping the preliminary image to obtain the image prompt, where the element comprise a face of the person.

Some examples of the method, apparatus, non-transitory computer readable medium, and system further include obtaining a style image depicting a style, where the first synthetic image and the second synthetic image are generated based on the style image and include the style. Some examples of the method, apparatus, non-transitory computer readable medium, and system further include obtaining a first noise input and a second noise input. Some examples further include denoising the first noise input based on the first scene prompt and the second noise input based on the second scene prompt to obtain the first synthetic image and the second synthetic image, respectively.

Some examples of the method, apparatus, non-transitory computer readable medium, and system further include generating a storyboard using the first synthetic image and the second synthetic image. Some examples of the method, apparatus, non-transitory computer readable medium, and system further include generating, using the language generation model, a first caption and second caption based on the first synthetic image and the second synthetic image, respectively, where the storyboard comprises a first panel including the first synthetic image and the first caption, and a second panel including the second synthetic image and the second caption.

Some examples of the method, apparatus, non-transitory computer readable medium, and system further include receiving a modification command indicating the first scene and a modified element. Some examples further include generating, using the language generation model, a modified scene prompt based on the modification command. Some examples further include generating, using the image generation model, a modified synthetic image based on the first scene and the modified element.

FIG. 1 shows an example of an image processing system according to aspects of the present disclosure. The example shown includes user 100, user device 105, image processing apparatus 110, cloud 115, database 120, and display panel 125. In some aspects, user device 105 includes display panel 125. Image processing apparatus 110 is an example of, or includes aspects of, the corresponding element described with reference to FIG. 5.

Referring to FIG. 1, user 100 provides a text prompt to image processing apparatus 110 via user device 105 and cloud 115. In some cases, the text prompt may be a description of a topic of a story. For example, the text prompt states “Blueberry's interdimensional adventure”. In some embodiments, user 100 provides an image prompt (e.g., a real image or a synthetic image) to the image processing apparatus 110 via user device 105 and cloud 115. For example, the image prompt depicts a character (e.g., Blueberry) to be generated in one or more story panels of the storyboard. In some cases, the image prompt is generated based on an identity text prompt using an image generation model.

In some embodiments, the image processing apparatus 110 includes a language generation model configured to generate a set of scene prompts based on the text prompt. In some embodiments, the image processing apparatus 110 includes an image generation model configured to receive the set of scene prompts and the image prompt to generate a set of synthetic images. For example, one or more of the synthetic image depicts the character from the image prompt in the scene described by the corresponding scene prompt. In some embodiments, the image processing apparatus 110 includes a storyboard component configured to respectively combine each of the synthetic images and each of the caption titles corresponding to the synthetic images to generate the storyboard. Image processing apparatus 110 displays the storyboard via display panel 125 of the user device 105 to user 100 via cloud 115.

User device 105 may be a personal computer, laptop computer, mainframe computer, palmtop computer, personal assistant, mobile device, or any other suitable processing apparatus. In some examples, user device 105 includes software that incorporates an image processing application. In some examples, the image processing application on user device 105 may include functions of image processing apparatus 110. In some cases, user device 105 may include a user interface that performs functions of the image processing apparatus 110.

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may be a graphical user interface (GUI). In some examples, a user interface may be represented in code in which the code is sent to the user device 105 and rendered locally by a browser. The process of using the image processing apparatus 110 is further described with reference to FIG. 2.

Image processing apparatus 110 is an example of, or includes aspects of, the corresponding element described with reference to FIG. 5. According to some aspects, image processing apparatus 110 includes a computer implemented network comprising a machine learning model, a language generation model, an image generation model, and a storyboard component. Image processing apparatus 110 further includes a processor unit, a memory unit, an I/O module, a user interface, and a training component. In some embodiments, image processing apparatus 110 further includes a communication interface, user interface components, and a bus as described with reference to FIG. 13. Additionally or alternatively, image processing apparatus 110 communicates with user device 105 and database 120 via cloud 115. Further detail regarding the operation of image processing apparatus 110 is described with reference to FIG. 2.

In some cases, image processing apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In some examples, cloud 115 is based on a local collection of switches in a single physical location.

According to some aspects, database 120 stores training data. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In other cases, the database controller may operate automatically without user interaction.

FIG. 2 shows an example of a method 200 for conditional image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

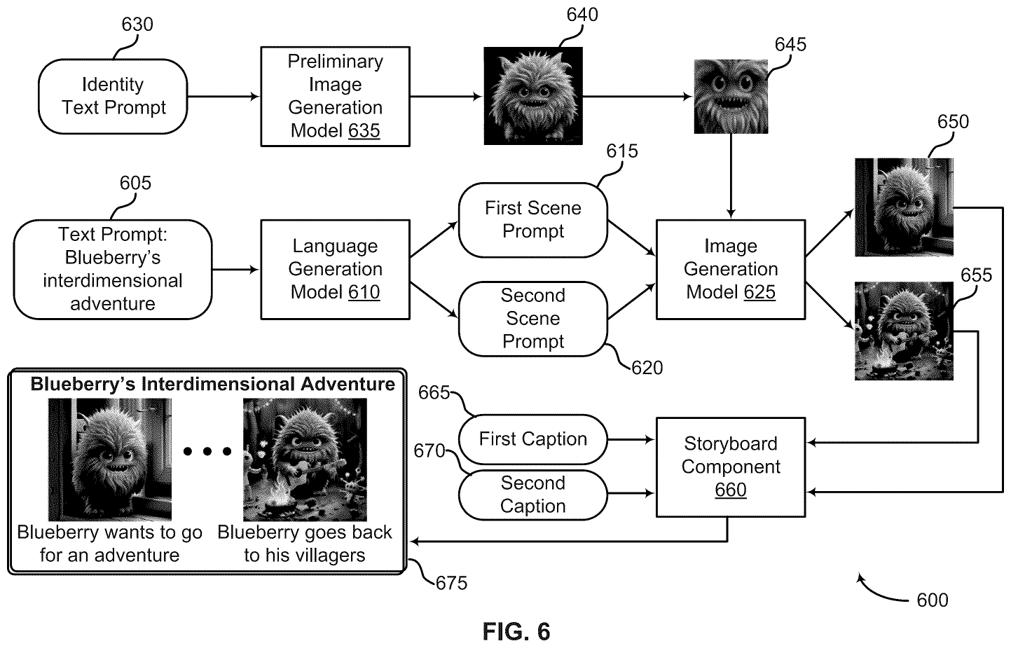

At operation 205, the system provides a text prompt. In some cases, the operations of this step refer to, or may be performed by, a user as described with reference to FIG. 1. In some cases, the user provides the text prompt to a language generation model of the system. In some aspects, the text prompt describes a high-level overview of the story. For example, the text prompt may state “Blueberry's interdimensional adventure.” In some cases, the user may provide additional inputs such as the number of panels to be generated in a storyboard. In some embodiments, the system performs prompt engineering to generate an input text prompt. In some cases, the input text prompt may include the text prompt prefixed or appended by the number of panels. For example, the input text prompt may state “create a storyboard of {story} with {n} panels,” where {story} indicates the text prompt and {n} indicates the number of panels to be generated in the storyboard. In some embodiments, the system may receive additional text input that describes one or more elements of the story from the user. In some embodiments, the user provides an image prompt depicting a character of the story to preserve the identity of the character generated in the storyboard. Further detail on identity preservation is described with reference to FIG. 6.

At operation 210, the system generates conditional guidance embedding. In some cases, the operations of this step refer to, or may be performed by, an image processing apparatus as described with reference to FIGS. 1 and 5. In some cases, the operations of this step refer to, or may be performed by, an image generation model as described with reference to FIGS. 5 and 6. In some embodiments, the language generation model is configured to generate a set of scene prompts based on the input text prompt, where the number of scene prompts corresponds to the number indicated by the input text prompt. In some aspects, the image generation model includes a text encoder, an image encoder, a multimodal encoder, a prior model, or a combination thereof. In some embodiments, the image generation model includes a text encoder configured to encode the set of scene prompts to generate a set of scene prompt embeddings, respectively. In some embodiments, an image encoder or a prior model of the image generation model generates a set of image embeddings based on the set of scene prompt embeddings, respectively, where the set of image embeddings are used to generate a set of synthetic images.

In some embodiments, the image generation model receives an image prompt that depicts a character. In some cases, the image prompt is generated based on an identity text prompt. In some cases, the image prompt is a real image. In some embodiments, the image encoder of the image generation model encodes the image prompt to generate an identity image embedding. In an embodiment, the identity image embedding is combined or concatenated with each of the set of image embeddings of the set of scene prompts. Accordingly, the system can ensure the identity preservation of the character in the synthetic images.

At operation 215, the system initialize noises input. In some cases, the operations of this step refer to, or may be performed by, an image processing apparatus as described with reference to FIGS. 1 and 5. In some cases, the operations of this step refer to, or may be performed by, an image generation model as described with reference to FIGS. 5-7. In some cases, the noise input including random noise is initialized. The noise input may be in a latent space. By initializing the image generation model with random noise, different variations of a synthetic image including the content described by the text conditioning (e.g., the text prompt) can be generated.

At operation 220, the system generates media content. In some cases, the operations of this step refer to, or may be performed by, an image processing apparatus as described with reference to FIGS. 1 and 5. In some cases, the operations of this step refer to, or may be performed by, an image generation model as described with reference to FIGS. 5 and 6. In some cases, the media content includes a storyboard. In some cases, the storyboard includes a set of synthetic images and a set of captions, respectively. For example, the synthetic image depicts the scene and elements described by the scene prompts. For example, captions describe each of the synthetic images on a high-level. In some cases, a synthetic image includes image pixels generated by the image generation model.

FIG. 3 shows an example of storyboard 325 generation according to aspects of the present disclosure. The example shown includes storyboard generation system 300, text prompt 305, image prompt 310, style prompt 315, machine learning model 320, and storyboard 325. In some embodiments, storyboard generation system 300 is implemented in a user interface.

Referring to FIG. 3, the storyboard generation system 300 receives text prompt 305 and generates storyboard 325. In some embodiments, the storyboard generation system 300 receives the text prompt 305 and the image prompt 310 as inputs to generate the storyboard 325. In some embodiments, the storyboard generation system 300 receives the text prompt 305, the image prompt 310, and the style prompt 315 as inputs to generate the storyboard 325. In some aspects, storyboard 325 includes a set of panels, where each of the panels includes a synthetic image and a caption title corresponding to the synthetic image.

According to some embodiments, the machine learning model 320 receives the text prompt 305 as an input. For example, the text prompt 305 describes a story such as “Blueberry's interdimensional adventure.” In some aspects, the machine learning model 320 includes a language generation model configured to generate a set of scene prompts based on the text prompt 305. For example, each of the scene prompts describes a scene, event, and/or action of the story. For example, the first scene prompt of the text prompt 305 may state “Blueberry is inspired by a book showing the outside world. Blueberry is in a room ready to go outside. Blueberry wants to go outside the world for an adventure.” For example, an intermediate scene prompt (e.g., the second scene prompt) of the text prompt 305 may state “Blueberry arrives to the human world and is stunned by the things Blueberry has never seen before. Blueberry moves his eyes around to capture the magnificent scenes.” For example, a final scene prompt (e.g., the third scene prompt) of the text prompt may state “Blueberry returns to his world and tells what he saw to his fellows. Blueberry is playing guitar around the bonfire and is surrounded by his fellows.”

In some aspects, the machine learning model 320 includes an image generation model configured to receive the set of scene prompts and generates a set of synthetic images corresponding to the set of scene prompts, respectively. In some cases, for example, the number of the scene prompt and the number of synthetic image are the same. In some aspects, the synthetic image depicts elements described by the scene prompts. In some embodiments, a caption (or caption title) is provided (e.g., by a user) to each of the synthetic image. In some cases, the language generation model of the machine learning model 320 generates a set of captions corresponding to the set of synthetic images, respectively. Machine learning model 320 combines each of the synthetic images and each of the captions to generate a set of panels (or storyboard panels) to generate the storyboard 325. Further detail on the image generation model is described with reference to FIGS. 5 and 6.

According to some embodiments, the machine learning model 320 receives the text prompt 305 and the image prompt 310 to generate the storyboard 325. For example, the image prompt 310 may be a real image or a synthetic image depicting the character described in the story. In some embodiments, the image prompt 310 is generated by using a text-to-image generation model or the image generation model of the machine learning model 320 based on an identity text prompt. For example, the identity text prompt describes the character in the story. In some cases, the image prompt 310 is a cropped image depicting the face of the character. The image generation model of the machine learning model 320 is able to extract identity information of the character based on the image prompt 310. For example, an image encoder of the image generation model generates an image embedding based on the image prompt 310, where the set of synthetic images is generated based on the image embedding. Accordingly, the set of synthetic images depicts the character from the image prompt 310 in a scene described by the scene prompts, where each of the synthetic images has a consistent identity of the character. In some aspects, the storyboard 325 includes the set of synthetic images and the corresponding set of captions.

According to some embodiments, the machine learning model 320 receives text prompt 305, the image prompt 310, and the style prompt 315 to generate the storyboard 325. In some cases, the style prompt 315 is an image depicting a specific style, such as a color style, a texture style, image style, etc. For example, the style prompt 315 depicts a red bicycle in a black-and-white background. The image generation model of the machine learning model 320 is able to extract the style information based on the style prompt 315. For example, an image encoder of the image generation model generates an image embedding based on the style prompt 315, where the set of synthetic images is generated based on the image embedding. In some cases, the image embedding of the style prompt 315 is combined (e.g., concatenated) with the image embedding of the image prompt and the combined image embedding is input into the image generation model. Accordingly, the set of synthetic images depicts, for example, the color style from the style prompt 315. For example, the character depicted in the synthetic images is red and the background scene is black-and-white. In some aspects, the storyboard 325 includes the set of synthetic images and the corresponding set of captions.

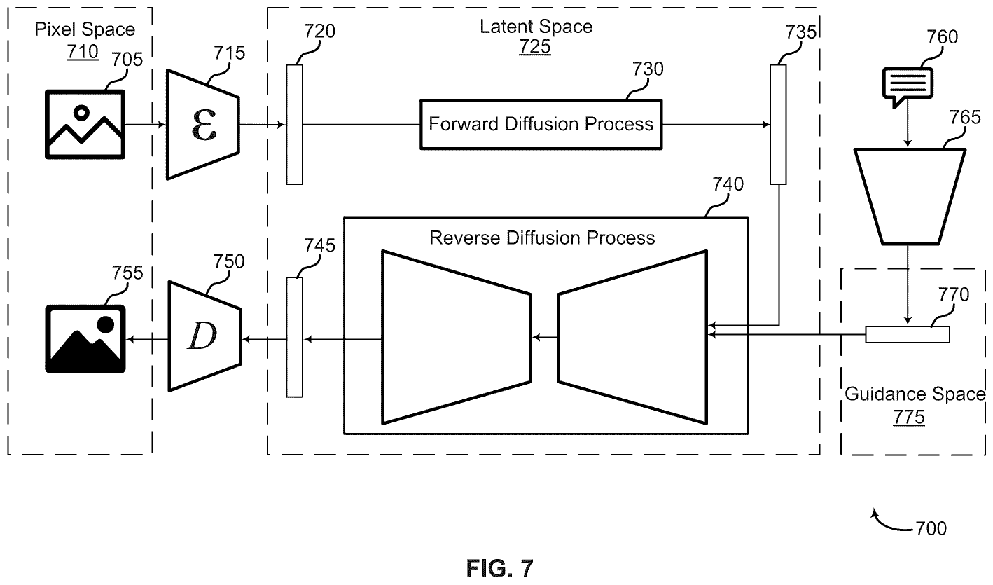

Text prompt 305 is an example of, or includes aspects of, the corresponding element described with reference to FIGS. 6 and 7. Image prompt 310 is an example of, or includes aspects of, the corresponding element described with reference to FIG. 6. Storyboard 325 is an example of, or includes aspects of, the corresponding element described with reference to FIG. 6.

FIG. 4 shows an example of a method 400 for generating a storyboard using a text prompt according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 405, the system obtains a text prompt describing a story. In some cases, the operations of this step refer to, or may be performed by, a language generation model as described with reference to FIGS. 5 and 6. In some cases, the text prompt describes one or more image elements to be generated in a synthetic image. For example, an image element is an image component or image feature that makes up the overall composition of an image, such as an object, entity, subject, shape, color, texture, pattern, background scene, visual attributes, and/or style. For example, the image element may be an animal such as a cat or dog, a person, an object such as a hat or table, a scene such as a beach or mountain top, or a combination thereof.

In some cases, for example, the story is structured sequence of one or more events, actions, or scenes in a chronological order. In some cases, for example, an event refers to a key occurrence or change in the state of the world or the characters. For example, an event may refer to a discovery, a conflict, a resolution, etc. In some cases, for example, an action refers to a decision and behavior of a character that drives the plot. For example, an action may be the character is performing or doing something. In some cases, for example, a scene refers to a specific setting or moment where an event or action takes place, such as a location or interaction between a character with the location or between a character with another character. In some cases, for example, a character may be a fictional person, an animal, an object, an entity, or a real person.

At operation 410, the system generates a first scene prompt and a second scene prompt based on the text prompt, where the first scene prompt describes a first scene of the story and the second scene prompt describes a second scene of the story. In some cases, the operations of this step refer to, or may be performed by, a language generation model as described with reference to FIGS. 5 and 6. In some cases, for example, a scene (e.g., the first scene or the second scene) refers to an element of the story (e.g., an event, action, scene, or a combination thereof). In some cases, the scene prompts may be a subtopic or a smaller unit within the story. In some cases, the scene represents a specific moment, event, or interaction that takes place at a particular time and location of the story. In some cases, one or more scenes are connected to the story. In some cases, the story encompasses the entire sequence of events (or scenes).

At operation 415, the system generates a first synthetic image and a second synthetic image based on the first scene prompt and the second scene prompt, respectively, where the first synthetic image depicts the first scene and the second synthetic image depicts the second scene. In some cases, the operations of this step refer to, or may be performed by, an image generation model as described with reference to FIGS. 5 and 6. In some cases, the system generates a plurality of synthetic images based on a plurality of scene prompts. For example, the synthetic image includes image pixels generated by the image generation model.

In some cases, the system generates a plurality of text embeddings based on the plurality of scene prompts (e.g., the first scene prompt and the second scene prompt). In some cases, a text embedding is a numerical vector that captures the semantic meaning of the text, encoding words, phrases, or sentences into a dense, continuous space. For example, the text embedding is encoded into a text embedding space, which is a low-dimensional vector space. The text embedding is generated by passing the text prompt through an encoder (e.g., a text encoder or multi-modal encoder) that learns the relationships between words based on the context within large corpora of text. In some cases, the text embedding represents textual features (e.g., the semantic meaning, relationship between words, or lexical features) of the text prompt.

In some cases, the system receives an image prompt and generates an image embedding based on the image prompt. For example, the image embedding is a numerical (or vector) representation of an image in a high-dimensional vector space. For example, image embedding captures the essential visual features or visual characteristics of an image, such as color, texture, shape, and spatial relationships.

In some cases, a text embedding space is a continuous, low-dimensional vector space where each vector represents the semantic meaning of the text. Points in the text embedding space are organized such that text with similar meanings are located near each other, reflecting the relationships between different words, phrases, or sentences based on contextual usage.

In some cases, an image embedding space is a high-dimensional vector space where each point corresponds to an image's visual representation. In the image embedding space, the distance between points reflects the similarity of the visual features of the images. In some cases, similar images are located closer to each other based on the characteristics encoded in the image embeddings.

In some cases, the text embedding and the image embedding are combined in a multimodal embedding space in the image generation model. For example, the multimodal embedding space (also known as a joint embedding space) is a high-dimensional space where different types of data (modalities), such as text, images, audio, or video, are represented in a unified manner. In the joint embedding space, data from various modalities are encoded into vectors that can be compared and related to each other directly, even though the data originate from different sources. For example, the text embedding of the text description “a cute cat” and the image embedding of the image of a cute cat would be mapped to nearby points in the joint embedding space. In some cases, the joint embedding space includes a shared semantic space configured to capture shared semantic meanings across modalities, where a text input can be matched to an image or vice versa.

In some cases, for example, an element of the story refers to the character of the story. For example, the character may be a real person, an object, an entity, or a fictional person. In some cases, a preliminary image refers to a real image depicting a real person. In some cases, a style image depicts a style such as a color style, image style, texture style, etc. In some cases, a storyboard comprises a set of panels, where each of the panels includes a synthetic image depicting an event, a scene, and/or an action of the story. In some cases, each of the panels includes a corresponding caption title summarizing the scene depicted in each of the synthetic images.

### System Architecture

In FIGS. 5-8 and 13, an apparatus and system for image processing include a memory component and a processing device coupled to the memory component, the processing device configured to perform operations comprising: obtaining a text prompt and an image prompt, where the text prompt describes a story and the image prompt depicts an element of the story, generating a first scene prompt and a second scene prompt based on the text prompt, where the first scene prompt describes a first scene of the story and the second scene prompt describes a second scene of the story, and generating a first synthetic image and a second synthetic image based on the image prompt, the first scene prompt, and the second scene prompt, where the first synthetic image depicts the first scene including the element and the second synthetic image depicts the second scene including the element.

In some aspects, the language generation model comprises a transformer model. In some aspects, the image generation model comprises a diffusion model. In some aspects, the image generation model includes a text encoder, an image encoder, a multi-modal encoder, a prior model, or a combination thereof.

FIG. 5 shows an example of an image processing apparatus 500 according to aspects of the present disclosure. The example shown includes image processing apparatus 500, processor unit 505, I/O module 510, and memory unit 515. In one aspect, memory unit 515 includes language generation model 520, image generation model 525, and storyboard component 530.

According to some embodiments of the present disclosure, image processing apparatus 500 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of the inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted. Image processing apparatus 500 is an example of, or includes aspects of, the corresponding element described with reference to FIG. 1.

Processor unit 505 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 505 is configured to operate a memory array using a memory controller. In other cases, a memory controller is integrated into the processor. In some cases, processor unit 505 is configured to execute computer-readable instructions stored in a memory to perform various functions. In some embodiments, processor unit 505 includes special-purpose components for modem processing, baseband processing, digital signal processing, or transmission processing. Processor unit 505 is an example of, or includes aspects of, the processor described with reference to FIG. 13.

I/O module 510 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 510 includes a user interface. A user interface may enable a user to interact with a device. In some embodiments, the user interface may include an audio device, such as an external speaker system, an external display device such as a display screen, or an input device (e.g., a remote control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna. I/O module 510 is an example of, or includes aspects of, the I/O interface described with reference to FIG. 13.

Examples of memory unit 515 include random access memory (RAM), read-only memory (ROM), or a hard disk. Examples of memory unit 515 include solid-state memory and a hard disk drive. In some examples, memory unit 515 is used to store computer-readable, computer-executable software including instructions that, when executed, cause a processor to perform various functions described herein.

In some cases, memory unit 515 includes, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 515 store information in the form of a logical state.

In one aspect, memory unit 515 includes a machine learning model. In one aspect, the machine learning model includes language generation model 520, image generation model 525, and storyboard component 530. Memory unit 515 is an example, of, or includes aspects of, the memory subsystem described with reference to FIG. 13.

In some cases, the machine learning model is a computational algorithm, model, or system designed to recognize patterns, make predictions, or perform a specific task (for example, image processing) without being explicitly programmed. According to some aspects, machine learning model is implemented as software stored in memory unit 515 and executable by processor unit 505, as firmware, as one or more hardware circuits, or as a combination thereof.

According to some embodiments of the present disclosure, machine learning model includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of the inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, machine learning model includes a computer-implemented CNN. CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

In one aspect, machine learning model includes machine learning parameters. Machine learning parameters, also known as model parameters or weights, are variables that provide behavior and characteristics of machine learning model. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that enables machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, machine learning model includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, machine learning model includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of the elements) is added to the embedded representation (n-dimensional vector) of each word. In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are the keys (vector representations of the words in the sequence) and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In the machine learning field, an attention mechanism (e.g., implemented in one or more ANNs) is a method of placing differing levels of importance on different elements of an input. Calculating attention may involve three basic steps. First, a similarity between the query and key vectors obtained from the input is computed to generate attention weights. Similarity functions used for this process can include the dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

An attention mechanism is a key component in some ANN architectures, particularly ANNs employed in natural language processing (NLP) and sequence-to-sequence tasks, that enables an ANN to focus on different parts of an input sequence when making predictions or generating output. Some sequence models (such as RNNs) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

The term “self-attention” refers to a machine learning model in which representations of the input interact with each other to determine attention weights for the input. Self-attention can be distinguished from other attention models because the attention weights are determined at least in part by the input.

According to some aspects, language generation model 520 is implemented as software stored in memory unit 515 and executable by processor unit 505, as firmware, as one or more hardware circuits, or as a combination thereof. According to some aspects, language generation model 520 obtains a text prompt describing a story. In some examples, language generation model 520 generates a first scene prompt and a second scene prompt based on the text prompt, where the first scene prompt describes a first scene of the story and the second scene prompt describes a second scene of the story.

In some examples, language generation model 520 generates a first caption and second caption based on the first synthetic image and the second synthetic image, respectively, where the storyboard includes a first panel including the first synthetic image and the first caption, and a second panel including the second synthetic image and the second caption. In some examples, language generation model 520 receives a modification command indicating the first scene and a modified element. In some examples, language generation model 520 generates a modified scene prompt based on the modification command.

According to some aspects, language generation model 520 obtains a text prompt and an image prompt, where the text prompt describes a story and the image prompt depicts an element of the story. In some examples, language generation model 520 is, a first scene prompt and a second scene prompt based on the text prompt, where the first scene prompt describes a first scene of the story and the second scene prompt describes a second scene of the story. In some aspects, the language generation model 520 includes a transformer model. Language generation model 520 is an example of, or includes aspects of, the corresponding element described with reference to FIG. 6.

According to some aspects, image generation model 525 is implemented as software stored in memory unit 515 and executable by processor unit 505, as firmware, as one or more hardware circuits, or as a combination thereof. According to some aspects, image generation model 525 generates a first synthetic image and a second synthetic image based on the first scene prompt and the second scene prompt, respectively, where the first synthetic image depicts the first scene and the second synthetic image depicts the second scene. In some examples, image generation model 525 obtains an image prompt depicting an element of the story, where the first synthetic image and the second synthetic image are generated based on the image prompt and depict the element.

In some examples, image generation model 525 obtains an identity text prompt describing the element. In some examples, image generation model 525 generates the image prompt based on the identity text prompt. In some examples, image generation model 525 obtains a preliminary image of a person. In some examples, image generation model 525 crops the preliminary image to obtain the image prompt, where the element include a face of the person. In some examples, image generation model 525 obtains a style image depicting a style, where the first synthetic image and the second synthetic image are generated based on the style image and include the style.

In some examples, image generation model 525 obtains a first noise input and a second noise input. In some examples, image generation model 525 denoises the first noise input based on the first scene prompt and the second noise input based on the second scene prompt to obtain the first synthetic image and the second synthetic image, respectively. In some examples, image generation model 525 generates a modified synthetic image based on the first scene and the modified element.

According to some aspects, image generation model 525 generates a first synthetic image and a second synthetic image based on the image prompt, the first scene prompt, and the second scene prompt, where the first synthetic image depicts the first scene including the element and the second synthetic image depicts the second scene including the element. In some aspects, the image generation model 525 includes a diffusion model.

According to some aspects, the image generation model 525 includes a text encoder, an image encoder, a multimodal encoder, a prior model, or a combination thereof. In some examples, the text encoder is a neural network that converts a text prompt (e.g., words, sentences, etc.) into a text embedding (e.g., a numeral vector representation) that captures the semantic meaning of the text prompt. In some examples, the image encoder is a neural network that receives an input image or an image prompt and generates an image embedding that includes visual features of the image encoded in a low-dimensional vector space. In some cases, image encoder includes convolutional neural network (CNN). In some examples, the multimodal encoder receives input data from multiple modalities (e.g., text, image, audio, video, etc.) and generate an embedding having a unified representation. In some cases, for example, the multimodal encoder may generate a text embedding based on an input text, and may generate an image embedding based on an input image. The multimodal encoder may combine the text embedding and the image embedding to generate a combined embedding in the same vector space (or embedding space).

In some cases, the prior model converts a text embedding into an image embedding. In some cases, the prior model is a diffusion-based prior model that includes an iterative process beginning from a noisy state (e.g., a noisy version of text embedding) and gradually reduces the noise to obtain the final output (e.g., the predicted image embedding). In some cases, the prior model is a transformer-based prior model that coverts the text embedding into an image embedding. For example, the transformer includes a plurality of transformer layers that takes the text embedding and models complex relationships and dependencies across the embedding's dimensions, and maps the text embedding into the image embedding, which captures more visual information than the text embedding. Image generation model 525 is an example of, or includes aspects of, the corresponding element described with reference to FIG. 6.

According to some aspects, storyboard component 530 is implemented as software stored in memory unit 515 and executable by processor unit 505, as firmware, as one or more hardware circuits, or as a combination thereof. According to some aspects, storyboard component 530 generates a storyboard using the first synthetic image and the second synthetic image. In some aspects, the storyboard comprises a first panel including the first synthetic image and a first caption, and a second panel including the second synthetic image and a second caption. Storyboard component 530 is an example of, or includes aspects of, the corresponding element described with reference to FIG. 6.

According to some aspects, image processing apparatus 500 includes a training component. The training component is implemented as software stored in memory unit 515 and executable by processor unit 505, as firmware, as one or more hardware circuits, or as a combination thereof. According to some embodiments, the training component is implemented as software stored in a memory unit and executable by a processor in the processor unit of a separate computing device, as firmware in the separate computing device, as one or more hardware circuits of the separate computing device, or as a combination thereof. In some examples, the training component is part of another apparatus other than image processing apparatus 500 and communicates with the image processing apparatus 500. In some examples, training component is part of image processing apparatus 500. According to some aspects, the training component trains the language generation model 520 and the image generation model 525 jointly or separately.

FIG. 6 shows an example of a storyboard 675 generation system according to aspects of the present disclosure. The example shown includes machine learning system 600, text prompt 605, language generation model 610, first scene prompt 615, second scene prompt 620, image generation model 625, identity text prompt 630, preliminary image generation model 635, preliminary output image 640, image prompt 645, first synthetic image 650, second synthetic image 655, storyboard component 660, first caption 665, second caption 670, and storyboard 675. In some aspects, machine learning system 600 includes language generation model 610, image generation model 625, and storyboard component 660. In some embodiments, machine learning system 600 further includes preliminary image generation model 635.

Referring to FIG. 6, machine learning system 600 receives text prompt 605 and generates storyboard 675. In some embodiments, language generation model 610 receives text prompt 605 and generates first scene prompt 615 and second scene prompt 620. For example, text prompt 605 describes a story such as “Blueberry's interdimensional adventure.” In one aspect, the language generation model 610 includes a transformer model. For example, the transformer architecture allows the language generation model 610 to understand and generate natural language outputs. In some cases, the language generation model 610 includes an input embedding layer configured to convert a text input (e.g., the text prompt 605) into a text embedding, where the text embedding is a numerical representation of words that represents the meaning and relationship. In some cases, the language generation model 610 includes a positional encoding that encodes the position information about the order of the tokens in the input text.

In some aspects, the language generation model 610 includes a multi-head self-attention layer, which focuses on different parts of the input sequence while processing each token of the input text. In some cases, the attention mechanism allows the model to learn different relationships between words in parallel. Each token in the input text attends to every other token in the sequence, which enables the model to understand long-range dependencies and relationships. In some aspects, the language generation model 610 includes a feedforward network that passes the processed tokens from the multi-head self-attention layer. In some embodiments, the language generation model 610 includes a normalization layer that scales the output to a target output. In some embodiments, the language generation model 610 includes one or more stacked transformer layers comprising one or more self-attention layers and feedforward layers. In some aspects, the language generation model 610 includes a decoder configured to generate predicted tokens in the sequence based on the input text. In some cases, the decoder generates a predicted text embedding of an output text. In some aspects, the language generation model 610 includes an output layer configured to generate the output text based on the input text. For example, the output text is the first scene prompt 615 and second scene prompt 620. In some embodiments, the language generation model generates a plurality of scene prompts based on the text prompt 605.

According to some embodiments, the machine learning system 600 performs prompt engineering using the text prompt 605 to obtain a modified text prompt. For example, the modified text prompt may include the text prompt 605 prefixed or appended by the number of panels. For example, the modified text prompt may state “create a storyboard of {story} with {n} panels,” where {story} indicates the text prompt 605 and {n} indicates the number of panels to be generated in the storyboard 675. In some cases, the number of scene prompts is generated based on the number indicated in the modified text prompt.

In some embodiments, the first scene prompt 615 and second scene prompt 620 are provided to the image generation model 625 to generate first synthetic image 650 and second synthetic image 655, respectively. In some embodiments, the image generation model 625 further receives image prompt 645 to generate the first synthetic image 650 and second synthetic image 655. For example, preliminary image generation model 635 receives identity text prompt 630 describing a character and generates a preliminary output image 640 depicting the character. For example, the identity text prompt 630 may state “An image of a blue furball cartoon character.” In some embodiments, the preliminary image generation model 635 is a pre-trained image generation model. In some embodiments, the preliminary image generation model 635 is the image generation model 625. In some cases, an image prompt 645 is generated based on the preliminary output image 640. For example, a facial region of the character depicted in the preliminary output image 640 is cropped to obtain the image prompt 645. The image prompt 645 is provided to the image generation model 625 to ensure that the character depicted in the synthetic images (e.g., the first synthetic image 650 and second synthetic image 655) is consistent and the identity of the character is preserved.

In some embodiments, preliminary output image 640 is used as the image prompt 645. For example, when the identity text prompt 630 describes a fictional character (e.g., a blue furball cartoon character), the preliminary output image 640 depicting the whole fictional character is provided to the image generation model 625 to account for the attributes of the fictional character, such as ears, clothes, shape, and size. In some embodiments, when the preliminary output image 640 depicts a human character (e.g., a model-generated image depicting human or a real image depicting a human), the facial region of the human depicted in the preliminary output image 640 is cropped to obtain the image prompt 645. Accordingly, the identity of the human character can be preserved.

According to some embodiments, image generation model 625 includes a text encoder, an image encoder, a multimodal encoder, a prior model, or a combination thereof. In some embodiments, the image generation model 625 includes a text encoder configured to encode the set of scene prompts (e.g., the first scene prompt 615 and the second scene prompt 620) to generate a set of scene prompt embeddings, respectively. In some embodiments, the set of scene prompt embeddings is used to generate a set of synthetic images (the first synthetic image 650 and second synthetic image 655). In some embodiments, an image encoder or a prior model of the image generation model 625 generates a set of image embeddings based on the set of scene prompt embeddings, respectively, where the set of image embeddings are used to generate a set of synthetic images.

In some embodiments, the image generation model 625 receives an image prompt 645 that depicts a character. In some cases, the image prompt 645 is a real image. In some embodiments, the image encoder of the image generation model 625 encodes the image prompt 645 to generate an identity image embedding. In some aspects, the identity image embedding includes information of the identity of the character depicted in the image prompt 645. In an embodiment, the identity image embedding is combined or concatenated with each of the set of image embeddings of the set of scene prompts. In one aspect, the set of synthetic images is generated based on the concatenated image embeddings.

According to some aspects, the first synthetic image 650, second synthetic image 655, first caption 665, and second caption 670 are provided to a storyboard component 660 to generate the storyboard 675. In some embodiments, first caption 665 and second caption 670 are provided by a user. In some embodiments, the first caption 665 and second caption 670 are generated based on the language generation model 610. In some cases, the storyboard component 660 combines the first synthetic image 650 and the first caption 665 to generate a first panel of the storyboard 675. In some cases, the storyboard component 660 combines the second synthetic image 655 and the second caption 670 to generate a second panel of the storyboard 675. In some aspects, the first panel and the second panel are combined to generate the storyboard. In some cases, the storyboard includes a plurality of panels.

Text prompt 605 is an example of, or includes aspects of, the corresponding element described with reference to FIGS. 3 and 7. Language generation model 610 is an example of, or includes aspects of, the corresponding element described with reference to FIG. 5. Image generation model 625 is an example of, or includes aspects of, the corresponding element described with reference to FIG. 5.

Image prompt 645 is an example of, or includes aspects of, the corresponding element described with reference to FIG. 3. Storyboard component 660 is an example of, or includes aspects of, the corresponding element described with reference to FIG. 5. Storyboard 675 is an example of, or includes aspects of, the corresponding element described with reference to FIG. 3.

FIG. 7 shows an example of an image generation model according to aspects of the present disclosure. The example shown includes diffusion model 700, original image 705, pixel space 710, image encoder 715, original image feature 720, latent space 725, forward diffusion process 730, noisy feature 735, reverse diffusion process 740, denoised image feature 745, image decoder 750, output image 755, text prompt 760, text encoder 765, guidance feature 770, and guidance space 775.

Diffusion models are a class of generative neural networks that can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance, color guidance, style guidance, and image guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (e.g., latent diffusion).

Diffusion models work by iteratively adding noise to the data during a forward process and then learning to recover the data by denoising the data during a reverse process. For example, during training, diffusion model 700 may take an original image 705 in a pixel space 710 as input and apply an image encoder 715 to convert original image 705 into original image feature 720 in a latent space 725. Then, a forward diffusion process 730 gradually adds noise to the original image feature 720 to obtain noisy feature 735 (also in latent space 725) at various noise levels.

Next, a reverse diffusion process 740 (e.g., a U-Net ANN) gradually removes the noise from the noisy feature 735 at the various noise levels to obtain the denoised image feature 745 in latent space 725. In some examples, denoised image feature 745 is compared to the original image feature 720 at each of the various noise levels, and parameters of the reverse diffusion process 740 of the diffusion model are updated based on the comparison. Then, an image decoder 750 decodes the denoised image feature 745 to obtain an output image 755 in pixel space 710. In some cases, an output image 755 is created at each of the various noise levels. The output image 755 can be compared to the original image 705 to train the reverse diffusion process 740. In some cases, output image 755 refers to the synthetic image (e.g., described with reference to FIG. 6).

In some cases, image encoder 715 and image decoder 750 are pre-trained prior to training the reverse diffusion process 740. In some examples, image encoder 715 and image decoder 750 are trained jointly, or the image encoder 715 and image decoder 750 are fine-tuned jointly with the reverse diffusion process 740.

The reverse diffusion process 740 can also be guided based on a text prompt 760, or another guidance prompt, such as an image, a layout, a style, a color, a segmentation map, etc. The text prompt 760 can be encoded using a text encoder 765 (e.g., a multimodal encoder) to obtain guidance feature 770 in guidance space 775. The guidance feature 770 can be combined with the noisy feature 735 at one or more layers of the reverse diffusion process 740 to ensure that the output image 755 includes content described by the text prompt 760. For example, guidance feature 770 can be combined with the noisy feature 735 using a cross-attention block within the reverse diffusion process 740.

Cross-attention, also known as multi-head attention, is an extension of the attention mechanism used in some ANNs, for example, for NLP tasks. In some cases, cross-attention attends to multiple parts of an input sequence simultaneously, capturing interactions and dependencies between different elements. In cross-attention, there are two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring the similarity between each query representation and the key representations, where a higher similarity indicates that more attention is given to a key element. An attention score indicates the importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing the machine learning model to understand the context and generate more accurate and contextually relevant outputs.

In some examples, diffusion models are based on a neural network architecture known as a U-Net. The U-Net takes input features having an initial resolution and an initial number of channels, and processes the input features using an initial neural network layer (e.g., a convolutional network layer) to generate intermediate features. The intermediate features are then down-sampled using a down-sampling layer such that down-sampled features have a resolution less than the initial resolution and a number of channels greater than the initial number of channels.

This process is repeated multiple times, and then the process is reversed. For example, the down-sampled features are up-sampled using the up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

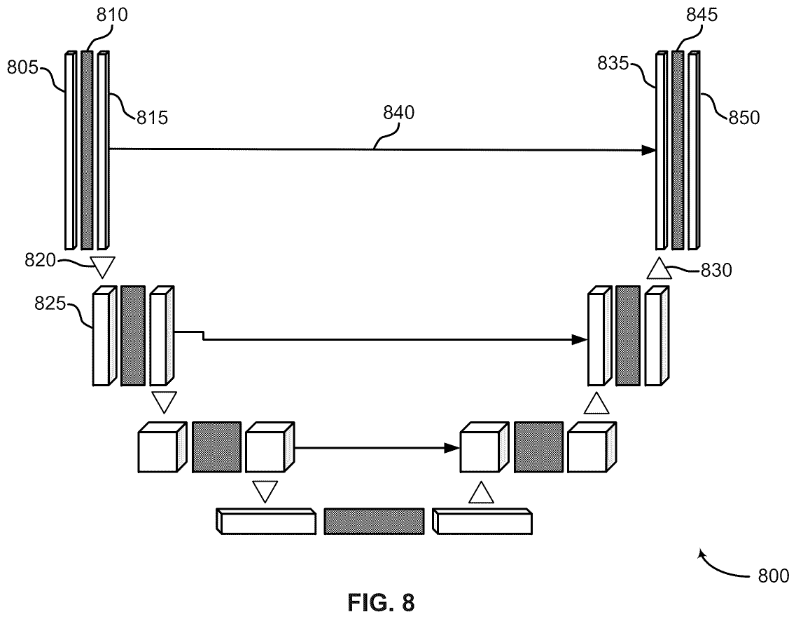

In some cases, a U-Net takes additional input features to produce conditionally generated output. For example, the additional input features may include a vector representation of an input prompt. The additional input features can be combined with the intermediate features within the neural network at one or more layers. For example, a cross-attention module can be used to combine the additional input features and the intermediate features. Further detail on the U-Net is described with reference to FIG. 8.

A diffusion process may also be modified based on conditional guidance. In some cases, a user provides a text prompt (e.g., text prompt 760) describing content to be included in a generated image. In some examples, guidance can be provided in a form other than text, such as via an image, a sketch, a color, a style, or a layout. The system converts text prompt 760 (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the diffusion model 700 generates an image based on the noise map and the conditional guidance vector.

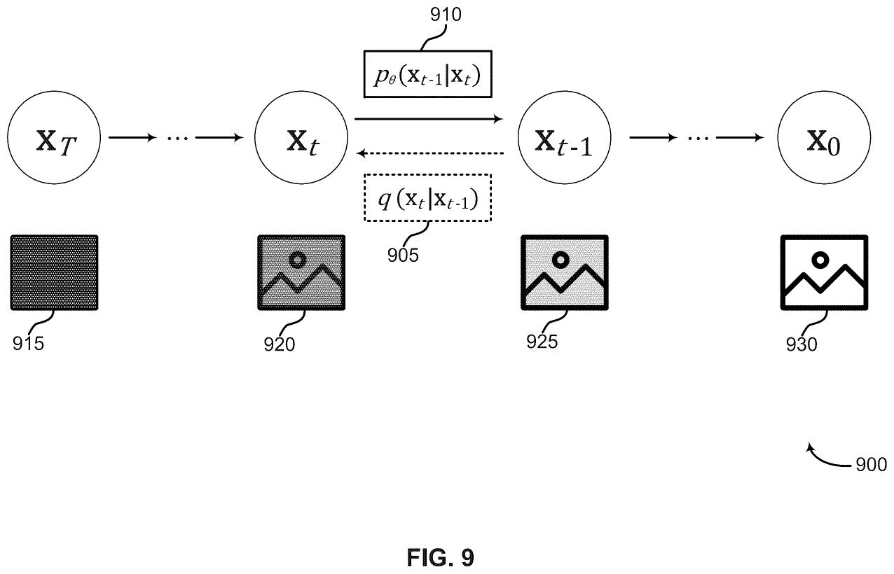

A diffusion process can include both a forward diffusion process 730 for adding noise to an image (e.g., original image 705) or features (e.g., original image feature 720) in a latent space 725 and a reverse diffusion process 740 for denoising the images (or features) to obtain a denoised image (e.g., output image 755). The forward diffusion process 730 can be represented as q(xₜ|xₜ₋₁), and the reverse diffusion process 740 can be represented as p_{θ}(xₜ₋₁|xₜ). Further detail on the diffusion process is described with reference to FIG. 9.

A diffusion model 700 may be trained using both a forward diffusion process 730 and a reverse diffusion process 740. In one example, the user initializes an untrained model. Initialization can include defining the architecture of the model and establishing initial values for the model parameters. In some cases, the initialization can include defining hyper-parameters such as the number of layers, the resolution and channels of each layer block, the location of skip connections, and the like.

The system then adds noise to a training image using a forward diffusion process 730 in N stages. In some cases, the forward diffusion process 730 is a fixed process where Gaussian noise is successively added to an image. In latent diffusion models, the Gaussian noise may be successively added to features (e.g., original image feature 720) in a latent space 725.

At each stage n, starting with stage N, a reverse diffusion process 740 is used to predict the image or image features at stage n−1. For example, the reverse diffusion process 740 can predict the noise that was added by the forward diffusion process 730, and the predicted noise can be removed from the image to obtain the predicted image. In some cases, an original image 705 is predicted at each stage of the training process.

The training component (e.g., training component described with reference to FIG. 5) compares predicted image (or image features) at stage n−1 to an actual image (or image features), such as the image at stage n−1 or the original input image. For example, given observed data x, the diffusion model 700 may be trained to minimize the variational upper bound of the negative log-likelihood −log p_{θ}(x) of the training data. The training component then updates parameters of the diffusion model 700 based on the comparison. For example, parameters of a U-Net may be updated using gradient descent. Time-dependent parameters of the Gaussian transitions can also be learned. Further detail on training the diffusion model is described with reference to FIG. 12.

Original image 705 is an example of, or includes aspects of, the corresponding element described with reference to FIG. 9. Forward diffusion process 730 is an example of, or includes aspects of, the corresponding element described with reference to FIG. 9. Reverse diffusion process 740 is an example of, or includes aspects of, the corresponding element described with reference to FIG. 9. Text prompt 760 is an example of, or includes aspects of, the corresponding element described with reference to FIGS. 3 and 6.

FIG. 8 shows an example of a U-Net 800 architecture according to aspects of the present disclosure. The example shown includes U-Net 800, input feature 805, initial neural network layer 810, intermediate feature 815, down-sampling layer 820, down-sampled feature 825, up-sampling process 830, up-sampled feature 835, skip connection 840, final neural network layer 845, and output feature 850.

In some examples, U-Net 800 is an example of the component that performs the reverse diffusion process 740 of diffusion model 700 described with reference to FIG. 7 and includes architectural elements of the image generation model 525 described with reference to FIG. 5. The U-Net 800 depicted in FIG. 8 is an example of, or includes aspects of, the architecture used within the reverse diffusion process described with reference to FIG. 7.

In some examples, diffusion models are based on a neural network architecture known as a U-Net. The U-Net 800 takes input feature 805 having an initial resolution and an initial number of channels, and processes the input feature 805 using an initial neural network layer 810 (e.g., a convolutional network layer) to produce intermediate feature 815. The intermediate feature 815 is then down-sampled using a down-sampling layer 820 such that the down-sampled feature 825 has a resolution less than the initial resolution and a number of channels greater than the initial number of channels.

This process is repeated multiple times, and then the process is reversed. For example, the down-sampled feature 825 is up-sampled using up-sampling process 830 to obtain up-sampled feature 835. The up-sampled feature 835 can be combined with intermediate feature 815 having the same resolution and number of channels via a skip connection 840. These inputs are processed using a final neural network layer 845 to produce output feature 850. In some cases, the output feature 850 has the same resolution as the initial resolution and the same number of channels as the initial number of channels.

In some cases, U-Net 800 takes an additional input feature to produce conditionally generated output. For example, the additional input feature could include a vector representation of an input prompt. The additional input feature can be combined with the intermediate feature 815 within the neural network at one or more layers. For example, a cross-attention module can be used to combine the additional input features and the intermediate feature 815.

### Diffusion Processing

FIG. 9 shows an example of a diffusion process 900 according to aspects of the present disclosure. The example shown includes diffusion process 900, forward diffusion process 905, reverse diffusion process 910, noisy image 915, first intermediate image 920, second intermediate image 925, and original image 930.

Diffusion process 900 can include forward diffusion process 905 for adding noise to original image 930 (e.g., original image 705 described with reference to FIG. 7) or features (e.g., original image feature 720 described with reference to FIG. 7) in a latent space. In some aspects, diffusion process 900 includes reverse diffusion process 910 for denoising the noisy image 915 (or image features) to obtain a denoised image (or original image 930). The forward diffusion process 905 can be represented as q(xₜ|xₜ₋₁), and the reverse diffusion process 910 can be represented as p_{θ}(xₜ₋₁|xₜ). In some cases, the forward diffusion process 905 is used during training to generate images with successively greater noise, and a neural network is trained to perform the reverse diffusion process 910 (e.g., to successively remove the noise).

In an example forward diffusion process 905 for a latent diffusion model (e.g., diffusion model 700 described with reference to FIG. 7), the diffusion model maps an observed variable x₀ (either in a pixel space or a latent space) to obtain intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse diffusion process 910. During the reverse diffusion process 910, the diffusion model begins with noisy data x_{T}, such as a noisy image 915 and denoises the data to obtain the p_{θ}(xₜ₋₁|xₜ). At each step t−1, the reverse diffusion process 910 takes xₜ, such as the first intermediate image 920, and t as input. Here, t represents a step in the sequence of transitions associated with different noise levels, The reverse diffusion process 910 outputs xₜ₋₁, such as the second intermediate image 925, iteratively until x_{T} is reverted back to x₀, the original image 930. The reverse diffusion process 910 can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T}; 0, l) is the pure noise distribution as the reverse diffusion process 910 takes the outcome of the forward diffusion process 905, a sample of pure noise, as input and Πₜ₌₁^{T}p_{θ}(xₜ₋₁|xₜ) represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

Forward diffusion process 905 is an example of, or includes aspects of, the corresponding element described with reference to FIG. 7. Reverse diffusion process 910 is an example of, or includes aspects of, the corresponding element described with reference to FIG. 7. Original image 930 is an example of, or includes aspects of, the corresponding element described with reference to FIG. 7.

### Prompt Modification

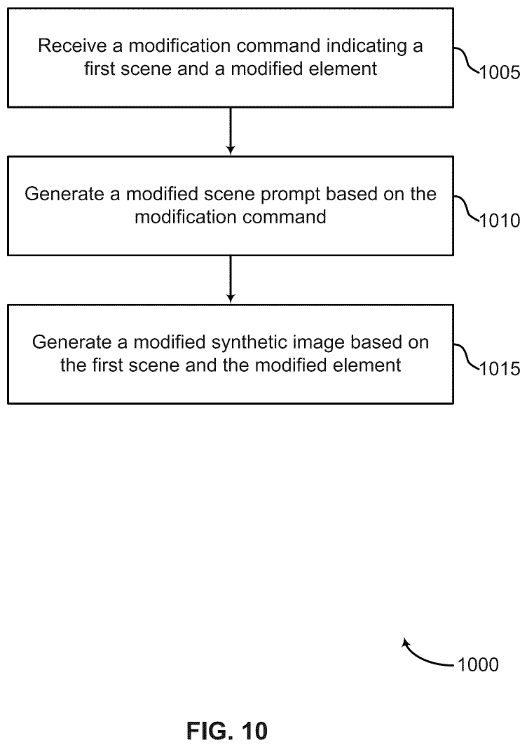

FIG. 10 shows an example of a method 1000 for modifying a scene prompt according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, the system receives a modification command indicating a first scene and a modified element. In some cases, the operations of this step refer to, or may be performed by, a language generation model as described with reference to FIGS. 5 and 6. In some cases, a user (e.g., the user 100 described with reference to FIG. 1) provides a modification command to the system. For example, the modification command describes a change from an element (e.g., room) in the scene prompt (e.g., the first scene prompt 615 described with reference to FIG. 6) to a different element (e.g., kitchen).

At operation 1010, the system generates a modified scene prompt based on the modification command. In some cases, the operations of this step refer to, or may be performed by, a language generation model as described with reference to FIGS. 5 and 6. In some cases, the language generation model generates a modified scene prompt in place of the first scene prompt. For example, as described with reference to FIG. 3, the modified scene prompt may state “Blueberry is inspired by a book showing the outside world. Blueberry is in a kitchen ready to go outside. Blueberry wants to go outside the world for an adventure.”

At operation 1015, the system generates a modified synthetic image based on the first scene and the modified element. In some cases, the operations of this step refer to, or may be performed by, an image generation model as described with reference to FIGS. 5 and 6. In some embodiments, the modified scene prompt is provided to the image generation model to generate a modified synthetic image depicting the change (e.g., from a room to kitchen). In some cases, one or more elements in one or more synthetic images may be modified based on one modification command.

### Training and Evaluation

FIG. 11 shows an example of a flow diagram depicting an algorithm as a step-by-step procedure in an example implementation of operations performable for training a machine learning model according to aspects of the present disclosure. In some embodiments, the procedure 1100 describes an operation of the training component described for configuring the image generation model 525 as described with reference to FIG. 5. The procedure 1100 provides one or more examples of generating training data, use of the training data to train a machine-learning model, and use of the trained machine-learning model to perform a task.

To begin in this example, a machine-learning system collects training data (block 1102) to be used as a basis to train a machine-learning model, which defines what is being modeled. The training data is collectible by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1104) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 1106). Initialization of the machine-learning model includes selecting a model architecture (block 1108) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, U-Net architecture, etc.

A loss function is also selected (block 1110). The loss function is utilized to measure a difference between an output of the machine-learning model (e.g., the model predictions) and target values (e.g., as expressed by the training data) to be used to train the machine-learning model. Additionally, an optimization algorithm is selected (block 1112) to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1116) examples of which include initializing weights and biases of nodes to increase efficiency in training and computational resources consumption as part of training. Hyperparameters are also set (block 1114) that are used to control training of the machine learning model, examples of which include regularization parameters, model parameters (e.g., a number of layers in a neural network), learning rate, batch sizes selected from the training data, and so on. The hyperparameters are set using a variety of techniques, including the use of a randomization technique, through the use of heuristics learned from other training scenarios, and so forth.

The machine-learning model is then trained using the training data (block 1118) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through the use of the selected loss function and backpropagation to optimize the performance of the machine-learning model to perform an associated task.

As part of training the machine-learning model, a determination is made as to whether a stopping criterion is met (decision block 1120), which is used to validate the machine-learning model. The stopping criterion is usable to reduce the overfitting of the machine-learning model, reduce computational resource consumption, and promote the ability of the machine-learning model to address unseen data not included as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1120), procedure 1100 continues the training of the machine-learning model using the training data (block 1118) in this example.

If the stopping criterion is met (“yes” from decision block 1120), the trained machine-learning model is then utilized to generate an output based on subsequent data (block 1122). The trained machine-learning model, for instance, is trained to perform a task as described above and therefore once trained is configured to perform that task based on subsequent data received as an input and processed by the machine-learning model.

FIG. 12 shows an example of a method for training a diffusion model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

In some embodiments, the method 1200 describes an operation of the training component described for training the image generation model 525 as described with reference to FIG. 5. The method 1200 represents an example for training a reverse diffusion process as described above with reference to FIG. 9. In some examples, these operations are performed by a system including a processor executing a set of codes to control functional elements of an apparatus, such as the image generation model described in FIG. 5.

At operation 1205, the system initializes untrained model. In some cases, the operations of this step refer to, or may be performed by, a training component as described with reference to FIG. 5. Initialization can include defining the architecture of the model and establishing initial values for the model parameters. In some cases, the initialization can include defining hyper-parameters such as the number of layers, the resolution and channels of each layer block, the location of skip connections, and the like.

At operation 1210, the system adds noise to media item using forward diffusion process in N stages. In some cases, the operations of this step refer to, or may be performed by, a training component as described with reference to FIG. 5. In some cases, for example, the media item is a training image. In some cases, the forward diffusion process is a fixed process where Gaussian noise is successively added to the media item (such as an original image). In latent diffusion models, the Gaussian noise may be successively added to features in a latent space.

At operation 1215, the system at each stage n, starting with stage N, predict media item for stage n−1. In some cases, the operations of this step refer to, or may be performed by, a training component as described with reference to FIG. 5. In some cases, the media item is a synthetic image generated using the image generation model. For example, the reverse diffusion process can predict the noise that was added by the forward diffusion process, and the predicted noise can be removed from the noise input to obtain the predicted output. In some cases, an original media item is predicted at each stage of the training process.

At operation 1220, the system compares the predicted media item (or feature) at stage n−1 to media at stage n−1. In some cases, for example, the system compares the synthetic image (or predicted image feature) at state n−1 to the ground-truth image (or ground-truth feature) at state n−1. In some cases, the operations of this step refer to, or may be performed by, a training component as described with reference to FIG. 5. For example, given observed data x, the diffusion model may be trained to minimize the variational upper bound of the negative log-likelihood −log p_{θ}(x) of the training data.

At operation 1225, the system updates parameters of the model based on the comparison. In some cases, the operations of this step refer to, or may be performed by, a training component as described with reference to FIG. 5. For example, parameters of a U-Net may be updated using gradient descent. Time-dependent parameters of the Gaussian transitions can also be learned.

### Computing Device

FIG. 13 shows an example of a computing device 1300 according to aspects of the present disclosure. The example shown includes computing device 1300, processor 1305, memory subsystem 1310, communication interface 1315, I/O interface 1320, user interface component 1325, and channel 1330.

In some embodiments, computing device 1300 is an example of, or includes aspects of, the image processing apparatus described with reference to FIGS. 1 and 5. In some embodiments, computing device 1300 includes processor 1305 that can execute instructions stored in memory subsystem 1310 to obtain a text prompt describing a story, generate a first scene prompt and a second scene prompt based on the text prompt, and generate a first synthetic image and a second synthetic image based on the first scene prompt and the second scene prompt, respectively.

According to some embodiments, processor 1305 includes one or more processors. In some cases, processor 1305 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, processor 1305 is configured to operate a memory array using a memory controller. In other cases, a memory controller is integrated into processor 1305. In some cases, processor 1305 is configured to execute computer-readable instructions stored in a memory to perform various functions. In some embodiments, processor 1305 includes special-purpose components for modem processing, baseband processing, digital signal processing, or transmission processing. Processor 1305 is an example of, or includes aspects of, the processor unit described with reference to FIG. 5.

According to some embodiments, memory subsystem 1310 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 1310 is an example of, or includes aspects of, the memory unit described with reference to FIG. 5.

According to some embodiments, communication interface 1315 operates at a boundary between communicating entities (such as computing device 1300, one or more user devices, a cloud, and one or more databases) and channel 1330 and can record and process communications. In some cases, communication interface 1315 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 1315.

According to some embodiments, I/O interface 1320 is controlled by an I/O controller to manage input and output signals for computing device 1300. In some cases, I/O interface 1320 manages peripherals not integrated into computing device 1300. In some cases, I/O interface 1320 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1320 or hardware components controlled by the I/O controller. I/O interface 1320 is an example of, or includes aspects of, the I/O module described with reference to FIG. 5.

According to some embodiments, user interface component 1325 enables a user to interact with computing device 1300. In some cases, user interface component 1325 includes an audio device, such as an external speaker system, an external display device such as a display screen, an input device (e.g., a remote-control device interfaced with a user interface directly or through the I/O controller), or a combination thereof.

The performance of apparatus, systems, and methods of the present disclosure have been evaluated, and results indicate embodiments of the present disclosure have obtained increased performance over conventional technology (e.g., conventional image generation models). Example experiments demonstrate that the image processing apparatus based on the present disclosure outperforms conventional image generation models. Details on the example use cases based on embodiments of the present disclosure are described with reference to FIG. 3.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a text prompt describing a story;
generating, using a language generation model, a first scene prompt and a second scene prompt based on the text prompt, wherein the first scene prompt describes a first scene of the story and the second scene prompt describes a second scene of the story; and
generating, using an image generation model, a first synthetic image and a second synthetic image based on the first scene prompt and the second scene prompt, respectively, wherein the first synthetic image depicts the first scene and the second synthetic image depicts the second scene.

2. The method of claim 1, further comprising:
obtaining an image prompt depicting an element of the story, wherein the first synthetic image and the second synthetic image are generated based on the image prompt and depict the element.

3. The method of claim 2, wherein obtaining the image prompt comprises:
obtaining an identity text prompt describing the element; and
generating the image prompt based on the identity text prompt.

4. The method of claim 2, wherein obtaining the image prompt comprises:
obtaining a preliminary image of a person; and
cropping the preliminary image to obtain the image prompt, wherein the element comprise a face of the person.

5. The method of claim 1, further comprising:
obtaining a style image depicting a style, wherein the first synthetic image and the second synthetic image are generated based on the style image and include the style.

6. The method of claim 1, wherein generating the first synthetic image and the second synthetic image comprises:
obtaining a first noise input and a second noise input; and
denoising the first noise input based on the first scene prompt and the second noise input based on the second scene prompt to obtain the first synthetic image and the second synthetic image, respectively.

7. The method of claim 1, further comprising:
generating a storyboard using the first synthetic image and the second synthetic image.

8. The method of claim 7, wherein generating the storyboard comprises:
generating, using the language generation model, a first caption and second caption based on the first synthetic image and the second synthetic image, respectively, wherein the storyboard comprises a first panel including the first synthetic image and the first caption, and a second panel including the second synthetic image and the second caption.

9. The method of claim 1, further comprising:
receiving a modification command indicating the first scene and a modified element;
generating, using the language generation model, a modified scene prompt based on the modification command; and
generating, using the image generation model, a modified synthetic image based on the first scene and the modified element.

10. A non-transitory computer readable medium storing code for image processing, the code comprising instructions that, when executed by at least one processor, cause the at least one processor to perform operations comprising:
obtaining a text prompt and an image prompt;
generating, using a language generation model, a first scene prompt and a second scene prompt based on the text prompt; and
generating, using an image generation model, a first synthetic image and a second synthetic image based on the image prompt and based on the first scene prompt and the second scene prompt, respectively.

11. The non-transitory computer readable medium of claim 10, wherein:
the image prompt comprises an image depicting an element of the story, wherein the first synthetic image and the second synthetic image depict the element from the image prompt.

12. The non-transitory computer readable medium of claim 10, wherein obtaining the image prompt comprises:
obtaining an identity text prompt describing the element; and
generating the image prompt based on the identity text prompt.

13. The non-transitory computer readable medium of claim 10, wherein obtaining the image prompt comprises:
obtaining a preliminary image of a person; and
cropping the preliminary image to obtain the image prompt, wherein the element comprise a face of the person.

14. The non-transitory computer readable medium of claim 10, wherein the code further comprises instructions that, when executed by the at least one processor, cause the at least one processor to perform operations comprising:
obtaining a style image depicting a style, wherein the first synthetic image and the second synthetic image are generated based on the style image and include the style.

15. The non-transitory computer readable medium of claim 10, wherein generating the first synthetic image and the second synthetic image comprises:
obtaining a first noise input and a second noise input; and
denoising the first noise input based on the first scene prompt and the second noise input based on the second scene prompt to obtain the first synthetic image and the second synthetic image, respectively.

16. The non-transitory computer readable medium of claim 10, wherein the code further comprises instructions that, when executed by the at least one processor, cause the at least one processor to perform operations comprising:
generating a storyboard using the first synthetic image and the second synthetic image.

17. The non-transitory computer readable medium of claim 10, wherein the code further comprises instructions that, when executed by the at least one processor, cause the at least one processor to perform operations comprising:
receiving a modification command indicating the first scene and a modified element;
generating, using the language generation model, a modified scene prompt based on the modification command; and
generating, using the image generation model, a modified synthetic image based on the first scene and the modified element.

18. A system comprising:
a memory component;
a processing device coupled to the memory component:
a language generation model comprising parameters stored in the memory component and configured to generate a first scene prompt and a second scene prompt based on a text prompt, wherein the first scene prompt describes a first scene of a story and the second scene prompt describes a second scene of the story; and
an image generation model comprising parameters stored in the memory component and configured to generate a first synthetic image and a second synthetic image based on the image prompt, the first scene prompt, and the second scene prompt, wherein the first synthetic image depicts the first scene including the element and the second synthetic image depicts the second scene including the element.

19. The system of claim 18, wherein:
the language generation model comprises a transformer model.

20. The system of claim 18, wherein:
the image generation model comprises a diffusion model.
